(19) United States
(12) Patent Application Publication
(10) Pub. No.: US 2013/0039846 A1
(43) Pub. Date: Feb. 14, 2013

(54) METHOD FOR PRODUCING HYDROGEN

(71) Applicant: Toshiharu Fukai, Nagano (JP)

(72) Inventor: Toshiharu Fukai, Nagano (JP)

(21) Appl. No.: 13/643,346

(22) PCT Filed: Apr. 22, 2011
(86) PCT No.: PCT/JP2011/059954

§ 371 Date: Oct. 25, 2012

(30) Foreign Application Priority Data
Apr. 27, 2010 (JP) 2010-101788

(51) Int. Cl. C01B 3/08; C01B 3/10

(52) U.S. Cl. 423/657

(57) ABSTRACT

The invention provides a method for producing hydrogen capable of easily obtaining hydrogen from water under lower temperature and pressure conditions as compared with a conventional method.

Water, aluminium 76 and at least one of sodium bicarbonate or sodium carbonate are fed into a container 60. Water in the container 60 is heated to 60° C. or higher by a heating means 90. A large amount of hydrogen can be generated in the container 60 from the aluminium 76 and the water contained therein.

### TECHNICAL FIELD

The invention relates to a method for producing hydrogen from water.

### TECHNICAL BACKGROUND

It is conventionally known that hydrogen is used as a fuel gas. A number of methods have been invented for producing hydrogen. For example, a method for generating hydrogen by thermally decomposing 100 wt of water or an IS (Iodine-Sulfur) method in which hydrogen is generated by thermally decomposing sulfuric acid to separate hydrogen by using iodine water is known. In IS method, hydrogen and oxygen are separated from water via three processes of Bunsen reaction, concentration and decomposition of hydrogen iodide, and concentration and decomposition of sulfuric acid (Patent Document 1).

In addition, as a method for generating hydrogen, a method of reacting an activated aluminium particle with water to generate hydrogen is known (Patent Document 2). An activated aluminium particle will be described based on an extraction from Patent Document 2. To produce an activated aluminium particle, firstly, a cut dust of aluminium is crashed with compression to be atomized to a size of 20 μm or smaller so that a crack (microcrack) is generated inside of the cut dust. Secondly, a thermal shock is applied to the cut dust with a temperature difference of approximately 40° C., and then the cut dust is applied with an activation treatment, for example, stored in water at a low temperature for about one week, thereby causing a microcrack to be transformed into a fine crack called nanocrack. More particularly, a cut dust of aluminium to which an activation treatment is applied to generate a fine crack called nanocrack is an activated aluminium particle.

Aluminium applied with an activation treatment has a fine crack in a particle, and when a water molecule enters into the crack to decompose a water molecule. It is considered that: a crack tip has extremely few water molecules, and around of which is surrounded by aluminium. A reaction in the crack tip is considered to take place in such a way that aluminium atoms competitively deprive an oxygen atom from the water molecule, causing an elementary reaction (7) as described below.

3Al+3H₂O→Al₂O₃+AlH₃+(3/2)H₂ (7)

More particularly, AlH₃ and Al₂O₃ are generated from the water molecule. Hydrogen generated by decomposing AlH₃ is spread while dispersing into the aluminium particles, and a part of hydrogen comes out to the surface as a hydrogen molecule. On the other hand, aluminium, which does not participate in the surface, is changed to a substance expressed by the following equation (8) through a normal surface reaction to generate hydrogen.

Al+3H₂O→Al(OH)₃+(3/2)H₂ (8)

Aluminium obtained through the overall reaction is expressed by the following equation (9).

2Al+3H₂O→Al₂O₃+3H₂ (9)

In a reaction expressed by (9), theoretically, the amount of hydrogen generated from 1 g of activated aluminium particle is approximately 1.35 L under conditions of 1 atm and 25° C., and water required for the reaction is approximately 2 mL. However, actually, since hydrogen is generated during the activation process, the total amount of hydrogen generated in the reaction becomes approximately 1.2 L.

### CITATION LIST

### Patent Document

[Patent Document 1] Japanese Patent Application Laid-Open Publication (JP-A) No. 2005-41764
[Patent Document 2] Reports of the Electronics Research Laboratory Fukuoka University Vol. 24, pp. 1-7 (2007)

### SUMMARY OF THE INVENTION

### Problems to be Solved by the Invention

It is said that in a method of obtaining hydrogen by thermally decomposing 100 wt of water, theoretically, water cannot be decomposed into hydrogen and oxygen unless a temperature of 3,000° C. to 5000° C. is applied since hydrogen and oxygen atoms are strongly bound to each other. In a method of obtaining hydrogen by thermally decomposing water at a temperature of 3000° C. or higher, generation of hydrogen has not been realized because thermal decomposition of water poses several problems such that a practical method for generating a high temperature of 3,000° C. or higher cannot be obtained, a facility for keeping a space conditioned to such a high temperature from outside cannot be established inexpensively, and that a means for continuously providing water into a high temperature space cannot be devised.

In the IS method described in Patent Document 1, a high-temperature gas reactor should be used as a heat source because a high temperature of approximately 900° C. is required. This type of high-temperature gas reactor has not been implemented because of some disadvantages such that production cost of the reactor is large, and hydrogen has to be produced through three processes, which leads to an increase in production cost of hydrogen, thereby lowering the cost-effectiveness.

In a method for reacting an activated aluminium particle with water shown in Patent Document 2, the activated aluminium particle has an extremely fine crack generated inside as compared with commercially available aluminium, leading to a significant increase in the production cost of hydrogen. More particularly, commercially available aluminium costs approximately 200 yen per 1 kg, whereas an activated aluminium particle disadvantageously costs approximately 1,500,000 yen to 2,000,000 yen per 1 kg. Furthermore, the activated aluminium particle is so small that it can be easily mixed in water, which causes a difficulty in separating the particle from water afterwards. For this reason, if generation of hydrogen is intended to be stopped during a time when hydrogen is generated by reacting the activated aluminium particle with water, there arises a disadvantage that separation of the activated aluminium particle from water is difficult, and thus generation of hydrogen cannot easily be stopped immediately.

The invention provides a method for producing hydrogen by using water and commercial aluminium, by which hydrogen can be easily separated from water under lower temperature and pressure conditions as compared with a conventional method. Another object of the invention is to provide a method for easily stopping generation of hydrogen immediately.

### Means for Solving the Problems

To achieve the above objects, a method for producing hydrogen of the invention is characterized in that 100 wt of water, 1. wt. or more of aluminium and 1 wt or more of either sodium bicarbonate or sodium carbonate are fed into a container, and an aqueous sodium bicarbonate solution or an aqueous sodium carbonate solution in the container is heated to 60° C. or higher by a heating means. The invention is characterized in that the aluminium has a weight of 10 wt or more. The invention is characterized in that at least one of the sodium bicarbonate or the sodium carbonate has to weight of 10 wt or more. The invention is characterized in that an accommodation means is vertically and movably provided in the container, and the accommodation means contains the aluminium therein, wherein the aluminium is immersed under a liquid surface within the container to generate hydrogen, while the aluminium is raised above the liquid surface within the container by raising the accommodation means to stop generation of hydrogen. The invention is characterized in that a discharge pipe for discharging water outside from the container is provided in the vicinity of the bottom of the container and an on-off valve is provided in the middle of the discharge pipe, wherein an aqueous sodium bicarbonate solution or an aqueous sodium carbonate solution in the container is discharged from the discharge pipe to stop generation of hydrogen. The invention is characterized in that a thermometer for measuring a temperature inside of the container and a barometer for measuring a pressure inside of the container are provided, and also a computer for operating the heating means in response to a temperature inside of the container measured by the thermometer and a pressure inside of the container measured by the barometer is provided, wherein the computer controls the heating means so that a temperature of an aqueous sodium bicarbonate solution or an aqueous sodium carbonate solution in the container is kept to a level that hydrogen can be generated maximally in a unit of time. The invention is characterized in that a temperature to which the aqueous sodium bicarbonate solution or the aqueous sodium carbonate solution in the container is heated and kept by the heating means is set at 86° C. to 97° C. The invention is characterized in that at least one of the sodium bicarbonate or the sodium carbonate is used to generate hydrogen, and a temperature at which the aqueous sodium bicarbonate solution is heated by the heating means is used as a temperature to evaporate the solution, a vertically movable accommodation means is provided in the container, wherein the mass of aluminium is contained in the accommodation means, and in the case of generating hydrogen, the mass of aluminium is positioned above the liquid surface in the container so that a vapor of the aqueous sodium bicarbonate solution is applied to the mass of aluminium. The invention is characterized in that a space between the aluminium and the liquid surface is isolated hermetically by using an isolation member to stop generation of hydrogen. The invention is characterized in that a discharge pipe for discharging water outside from the container is provided in the vicinity of the bottom of the container, an on-off valve is provided in the middle of the discharge pipe, and an aqueous sodium bicarbonate solution in the container is discharged from the discharge pipe to stop generation of hydrogen. The invention is characterized in that water to be fed into the container is a specific type of water generated in a process where water is passed firstly through an ion exchange resin, next through tourmaline, and subsequently through rocks including 65 to 76 wt of silica dioxide and comprising at least one of rhyolite or granite, either in this order or in the order tourmaline and the rocks are reversed. The invention is characterized in that tourmaline for generating the specific type of water is mixed with at least one of aluminium, stainless steel or silver metal. The invention is characterized in that the rhyolite is a rock comprising at least one of obsidian, pearlstone or pitchstones.

### EFFECT OF THE INVENTION

In a method for producing hydrogen according to the invention, water, aluminium and at least either of sodium bicarbonate or sodium carbonate are used to generate hydrogen. Since aluminium used in the invention may be commercially available inexpensive aluminium, hydrogen can be produced at a significantly lower cost than an activated aluminium particle in Patent Document 2. Moreover, in the invention, a heating temperature of water in the container is made lower than an evaporation temperature at highest, and generated hydrogen is sequentially taken out from the container, thus preventing a high temperature and high pressure condition in the container. Therefore, a special container to be used under a high temperature and high pressure condition is not needed, and therefore whole of the hydrogen production unit can be made at low-cost.

Since sodium bicarbonate and sodium carbonate can be used to prevent a membrane formed on a mass of aluminium, aluminium can be used not as a powder but as a mass. By using aluminium as a mass, the mass of aluminium can be placed on a shelf having a lot of small holes formed thereon and positioned above the liquid surface so that a vapor from the aqueous sodium bicarbonate solution or the aqueous sodium carbonate solution can be made contact with aluminium in the air. In this manner, a generation amount of hydrogen can be increased.

By using aluminium as a mass, the mass of aluminium can be positioned above the liquid surface. Thus, aluminium can be hermetically isolated from water in the container. As a result, if a state of hydrogen generation should be discontinued, generation of hydrogen can be stopped immediately by taking out aluminium from a container or by isolating aluminium from water in a container hermetically by using an isolation means, and thus, hydrogen can be freely used for various purposes in which hydrogen is used as energy.

In the invention, such type of water is used to generate hydrogen. However, particularly, if a specific type of water, which is generated in a process where water is passed firstly through an ion exchange resin, next through tourmaline, and subsequently through rocks including 65 to 76 wt of silica dioxide and comprising at least one of rhyolite or granite, either in this order or in the order tourmaline and the rocks are reversed, is used, 1.5 to 2 times larger amount of hydrogen can be obtained as compared with other types of water (e.g., purified water, hydrogen water or city water).

### BRIEF DESCRIPTION OF THE DRAWINGS

FIG. 1 is a configuration diagram showing an example of a production unit for producing a specific type of water (refreshed water) to be used in a method of producing hydrogen according to the invention.

FIG. 2 is a sectional view showing a water generator to be used for a production unit shown in FIG. 1.

FIG. 3 is a sectional view showing a major portion of an ion generator to be used for a production unit shown in FIG. 1.

FIG. 4 is a configuration diagram showing another example of a production unit for producing a specific type of water (refreshed water) to be used in a method for producing hydrogen according to the invention.

FIG. 5 is a sectional view showing an example a unit for generating hydrogen according to the invention.

FIG. 6 is a perspective view showing an accommodation means other than the accommodation means to be used in FIG. 5.

FIG. 7 is a table showing a time of hydrogen generation in various types of water by using 100 wt of water, 20 wt of aluminium and 20 wt of sodium bicarbonate.

FIG. 8 is a table showing a time of hydrogen generation in various types of water under conditions of using 100 wt of water and 20 wt of aluminium blended with 0.1, 1, 10, 20 or 30 wt of sodium bicarbonate.

FIG. 9 is a measurement analysis report showing the amount of hydrogen generated from 100 wt of water, 10 wt of aluminium and 20 wt of sodium bicarbonate.

FIG. 10 is a table showing as time at which hydrogen is generated stably in various types of water when using 100 wt of water, 20 wt of aluminium and 20 wt of sodium carbonate.

FIG. 11 is a table showing a time of hydrogen generation in various types of water under conditions of using 100 wt of water and 20 wt of aluminium blended with 0.1, 1, 10, 20 or 30 wt of sodium carbonate.

### ILLUSTRATION OF REFERENCE NUMERALS

10 First soft water generator
12 Second soft water generator
14 Ion generator
16 Rock accommodating container
32 on exchange resin
46 Tourmaline
48 Metal
54 Rock
60 Container
62 Body
64 Lid
70 Shelf
72 Accommodation means
76 Aluminium
77 Accommodation means
90 Heating means
95 Elevation means
98 Discharge pipe
100 On-off valve

### BEST MODE FOR CARRYING OUT THE INVENTION

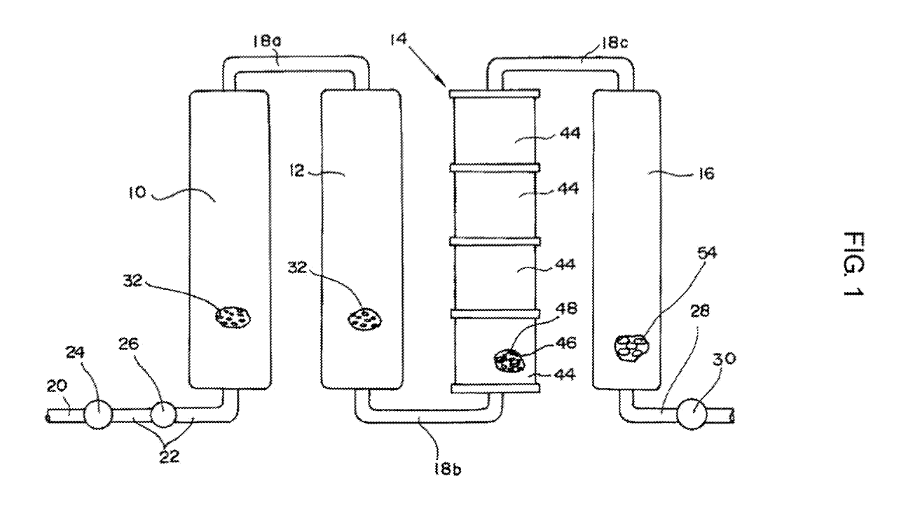

First, a specific type of water (hereinafter referred to as “refreshed water”) to be used in the invention will be described based on FIGS. 1 to 3 before describing a method for producing hydrogen of the invention. FIG. 1 is a configuration diagram showing an embodiment of a unit for producing refreshed water. A first soft water generator 10, a second soft water generator 12, an ion generator 14 and a rock accommodating container 16 are sequentially connected in series via connecting pipes 18a, 18b and 18c. For example, pressured water such as city water is introduced into the first soft water generator 10 via a connection pipe 22 from a water supply pipe 20. An inlet on-off valve 24 such as a faucet is arranged between the water supply pipe 20 and the connection pipe 22, and a check valve 26 is arranged in the middle of the connection pipe 22. A delivery pipe 28 is attached to the outlet side of the rock accommodating container 16, and an outlet on-off valve 30 is arranged in the tip or the middle of the delivery pipe 28.

With city water, water fed from the water supply pipe 20 is passed to the first soft water generator 10, the second soft water generator 12, the ion generator 14 and the rock accommodating container 16 in this order and is taken out from the delivery pipe 28 by opening the outlet on-off valve 30. With the case other than city water, water stored in water reservoir, not shown, is introduced through the supply pipe 20 into the first soft water generator 10 by means of a pump. In the case, a check valve 26 is provided between the pump and the first soft water generator 10.

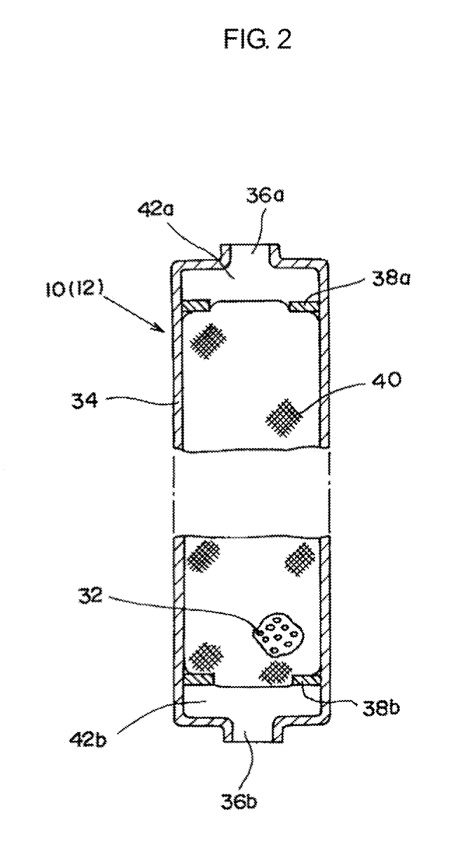

The first soft water generator 10 and the second soft water generator 12, respectively, contain a large quantity of a particulate ion exchange resin 32 therein, with its section being shown in FIG. 2. The soft water generators 10, 12, respectively, have a body 34 which is cylindrical in shape and has water outlet and inlet ports 36a, 36b at upper and lower ends thereof, respectively. The cylindrical body 34 is provided with shield members 38a, 38b at inner surfaces kept slightly away from the upper and lower ends thereof as, respectively, having an opening at the center thereof. The ion exchange resin 32 contained in a fine net 40 is accommodated between the paired shield members 38a, 38b. The reason why the shield members 38, each having the opening at the center thereof, are provided at the inner walls positioned slightly away from the outlet and inlet ports 36a, 36b is that the fine net 40 having ion exchange resin 32 is placed between the paired shield members 38 to establish spaces 42a, 42b in the vicinity of the outlet and inlet ports 36a, 36b, respectively. The passage of water through the central openings of the shield members 38a, 38b permits invariable contact of the water with the ion exchange resin 32. The reason why the on exchange resin 32 is placed in the net 40 is that the particulate ion exchange resin 32 can be wholly removed along with the net 40.

The first and second soft water generators 10 and 12, respectively have a height set, for example, at 80 cm and an inner diameter set at 10 cm herein. The accommodating height of the ion exchange resin 32 is set, for example, at 70 cm (permitting the upper and lower spaces 42a and 42b to be established). The accommodating height of the ion exchange resin 32 should be sufficient to satisfactorily effect ion exchange. On the other hand, when the height of the accommodated ion exchange resin 32 is too high (e.g. over about 200 cm in the height of the accommodated the ion exchange resin 32), the ion exchange resin 32 becomes resistant to the passage of water, resulting in a reduced flow rate of water passing through the inside of the soft water generator. Accordingly, the height of the accommodated the ion exchange resin 32 should be so set as not reducing the flow rate. The container accommodating the ion exchange resin 32 is divided into two. The reason for this is that the first and second soft water generators 10 and 12 are suppressed in height to substantially such a level as the ion generator and the rock accommodating container 16 and that it is avoided to reduce the flow rate owing to the pressure loss of water passing therethrough. Of course, the two soft water generators 10, 12 may be combined together to provide one soft water generator.

The ion exchange resin 32 serves to eliminate metal ions, such as Ca²⁺, Mg²⁺, Fe²⁺ and the like from water to provide soft water and especially to lower water hardness to a level close to zero. The ion exchange resin 32 used includes, for example, a strongly acidic cation exchange resin (RzSO₃Na) obtained by uniformly sulfonating a sphere-shaped styrene-divinylbenzene copolymer. This ion exchange resin 32 undergoes the following ion exchange resin with metal ions such as Ca²⁺, Mg²⁺, Fe²⁺ and the like.

₂RzSO₃Na+Ca²⁺→(RzSO₃)₂Ca+₂Na⁺

₂RzSO₃Na+Mg²⁺→(RzSO₃)₂Mg+₂Na⁺

₂RzSO₃Na+Fe²⁺→(RzSO₃)₂Fe+₂Na⁺

More particularly, Ca²⁺, Mg²⁺, Fe²⁺ and the like can be eliminated from water by passage through the ion exchange resin 32. The use of the strongly acidic cationic exchange resin as the ion exchange resin 32 results in formation of sodium ions (Na⁺). The ion exchange resin 32 may be one which is able to generate ions other than Na⁺ and should preferably be one which generates Na⁺. If city water is used, chlorine is contained in aside from the metal ions such as Ca²⁺, Mr²⁺, Fe²⁺ and the like. The chlorine undergoes no change when city water is passed through the ion exchange resin 32.

On the other hand, when water (H₂O) is passed through the ion exchange resin 32, the following changes take place.

H₂O→H⁺+OH⁻ (1)

H₂O+H⁺→H₃O⁺ (2)

As shown in (1) and (2) above, hydroxide ions (OH⁻) and hydronium ions (H₃O⁺) generate from water after passage through the ion exchange resin 32.

If hard water is used and passed through the on exchange resin 32, metal ions such as Ca²⁺, Mg²⁺, Fe²⁺ and the like are eliminated from the water to provide soft water. The passage through the ion exchange resin 32 permits Na⁺, OH⁻ and a hydronium ion (H₃O⁺) to be generated in the water. However, chlorine (Cl) present in city water passes as it is without undergoing ionization. It will be noted that no Na⁺ may be produced depending on the type of ion exchange resin 32.

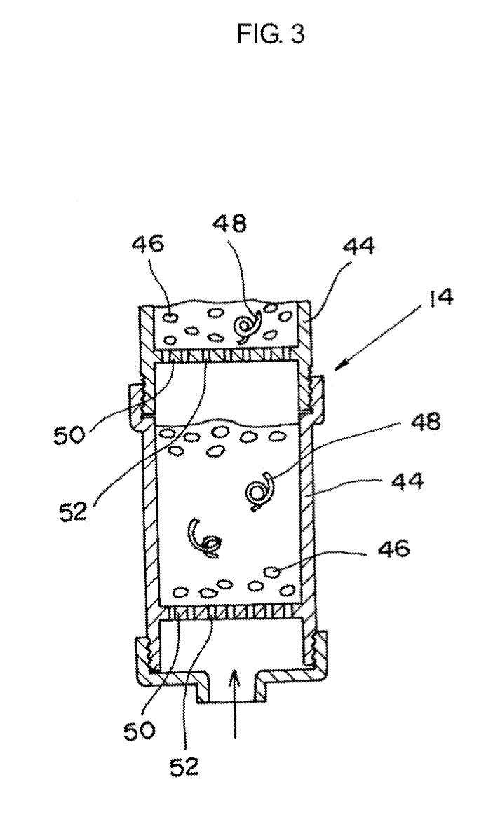

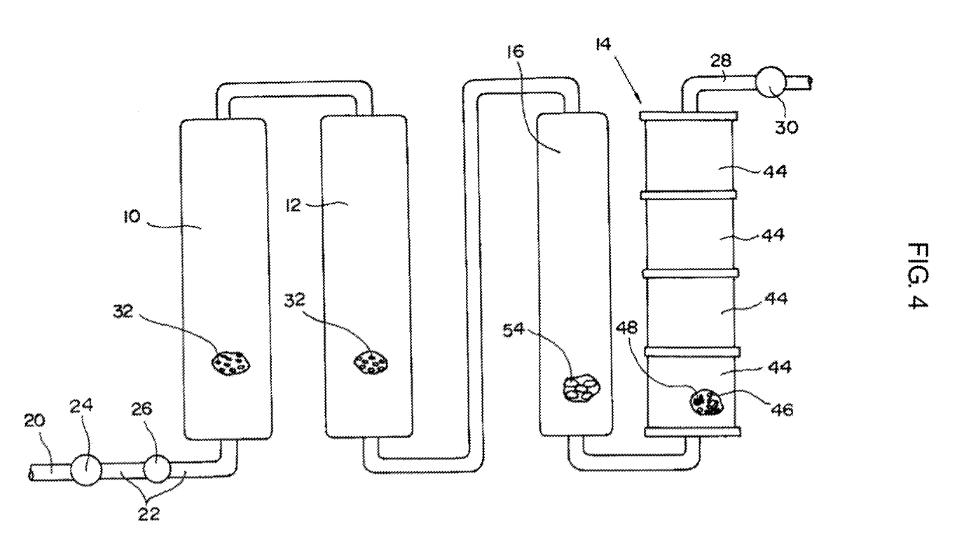

Next, a partial sectional view of the ion generator 14 is shown in FIG. 3. The ion generator 14 has a plurality of cartridges 44 arranged in a similar manner and continuously connected in series vertically. Individual cartridges 44 have particulate tourmaline 46 alone or a mixture of the particulate tourmaline 46 and a plate-shaped metal 48 accommodated therein. The tourmaline has plus and minus electrodes, with which an electromagnetic wave having 4˜14 micrometers is applied to water, so that clusters of water are cleaved off thereby generating hydronium ions (H₃O⁺). The electromagnetic wave having a wavelength of 4˜14 micrometers has an energy of 0.004 watts/cm². The tourmaline 46 used herein may consist of fine pieces of tourmaline. Alternatively, the tourmaline 46 may be a tourmaline mixture called tourmaline pellets, which are commercially available as containing tourmaline, a ceramic and aluminium oxide (which may contain silver therein) at mixing ratios by weight of about 10:80:10. The ceramic contained in the tourmaline pellets acts to keep the plus and minus electrodes separated from each other. The tourmaline 46 may be made by mixing not less than 10 wt % of tourmaline 46 with the ceramic and heating the resulting mixture at 800° C. or over, by which the tourmaline 46 that disappears within a given period of time (e.g. within about 3 months for a pellet diameter of 4 mm) under agitation in water can be made. The tourmaline 46 increases in strength when heated, thus ensuring a prolonged time of the disappearance. After passage through the ion exchange resin 32, water is converted to soft water having a hardness close to zero, and the tourmaline particles 46 are mutually collided with one another in the soft water. When using the soft water having a hardness close to zero, magnesium and calcium are prevented from being attached to the minus electrode of the tourmaline 46, thereby preventing the function as the plus and minus electrodes of the tourmaline 46 from lowering

The metal 48 used is at least one of aluminium, a stainless steel and silver. The metal 48 should preferably be one which is not corroded in water and is not soluble in water. Of these metals 48, aluminium has the bactericidal or antifungal action and the bleaching function, and stainless steel has the bactericidal or antifungal action and the detergency-improving action and silver has the bactericidal or antifungal action. Copper or lead cannot be used as the metal 48 because of its toxicity. Expensive materials such as gold cannot be adopted in view of costs. The tourmaline 46 and the metal 48 are mixed at a weight ratio of 10:1 to 1:10. Over the range, one of the materials becomes excessive, so that the effects of both materials cannot be shown simultaneously.

The cartridge 44 is in the form of a hollow cylinder opened at one end thereof and has a multitude of holes 52 at a bottom face 50 thereof. The size of the hole 52 is so set that where the tourmaline 46 and the metal 48 are placed in the cartridge 44, the tourmaline 46 and the metal 48 do not pass through the holes 52 at the bottom 50. As shown in FIG. 3, the respective cartridges 44 have a multitude of holes 52 at the bottom 50 thereof, on which the tourmaline 46 and the metal 48 are placed. The respective cartridges 44 are so set that water is run from the bottom toward the top of the cartridge 44. More particularly, in the respective cartridges 44, water passing through the multitude of holes 52 at the bottom 50 upwardly jets toward the tourmaline 46 and the metal 48. It will be noted that the size and number of the holes 52 are so set: city water has a high hydraulic pressure, such pressurized water is caused to vigorously collide with the tourmaline 46 and the metal 48 in the cartridge 44; and in this condition, the tourmaline 46 and the metal 48 are agitated by the force of the pressurized water in the cartridge 44. The agitation of the tourmaline by jetting water toward the tourmaline is that the tourmaline and water are frictionally contacted under the agitation, with the result that the electrodes are dissolved out in water to cleave the clusters of water, thereby generating a large quantity of hydronium ions (H₃O⁺).

In an instance of practical installment, four cartridges 4, each having an accommodation capacity with an inner diameter of 5 cm and a depth of 7 cm, are put one on another. The tourmaline 46 and the metal 48 are charged in the respective cartridges 44 in such an amount that the tourmaline 44 and the metal 48 can be freely moved within the cartridge 44. Although the number of the cartridges 44 may be increased or decreased, only one cartridge 44 having a great accommodation capacity may be used. The tourmaline 46 and the metal 48 are, respectively, placed in a plurality of cartridges 44 having a reduced capacity. The plural cartridges 44 are connected, in which the agitation efficiency of the tourmaline 46 and the metal 48 can be enhanced by the force of water. The tourmaline 46 contained in the cartridges 44 is disappears in several months by dissolution in water. The cartridges 44 are arranged as to be readily detached such as by screwing, permitting easy supplement of the tourmaline 46 in the respective, cartridges 44. It will be noted that it is not necessary to supplement the metal 48 which is not dissolved in water but all cartridges 44 containing the tourmaline 46 and the metal 48 may be replaced by a used ones. The capacity of the cartridge 44 may vary depending on the flow rate.

To increase anions to be added to water passing through the cartridge 44, tourmaline particles 46 are mutually collided with one another to produce plus and minus electrodes, and then the rubbed tourmaline particles 46 are brought into contact with water, thereby achieving an increase of anions. Furthermore, to cut a cluster of water to generate a large amount of hydronium ion (H₃O⁺), tourmaline 46 alone may be contained in the cartridge 44. However, when metal 48 is mixed with the tourmaline 46, they are brought into contact with each other, thereby causing tourmaline 46 to generate further increased anions.

The tourmaline 46 has plus and minus electrodes. When tourmaline is agitated in water, water (H₂O) dissociates into hydrogen ion (H⁺) and hydroxide ion (OH⁻)

H₂O→H⁺+OH⁻ (1)

Further, hydronium ions (H₃O⁺) having the surface activity are formed from the hydrogen ion (H⁺) and water (H₂O). The amount of the thus formed hydronium ions (H₂O⁺) is far much larger than that generated by means of the ion exchange resin 32.

H₂O+H⁺→H₃O⁺ (2)

Part of the hydronium ions (H₃O⁺) combines with water (H₂O) to form a hydroxyl ion (H₃O₂⁻) and hydrogen ions (H⁺)

H₃O⁺H₂O→H₃O₂⁻+₂H⁺ (3)

The water passed through the ion exchange resin 32 is further passed through the ion generator 14. Eventually, hydronium ions (H₃O⁺), hydroxyl ions (H₃O₂⁻), H⁺ and OH⁻ are generated in water. The chlorine (Cl) passed through the ion exchange resin 32 and the Na⁺ generated at the ion exchange resin 32 pass through the ion generator 14 as they are without undergoing any reaction.

Water passed through the ion generator 14 is then run through the rock accommodating container 16 which accommodates, a rock 54 including 65 to 76 wt of silica dioxide among igneous rocks. Of these igneous rocks (classified into volcanic rock and plutonic rock), as rocks 54 containing a large amount of silica dioxide, rhyolite such as obsidian, pearlstone or pitchstone may be used as a volcanic rock, and otherwise granite may be used as a plutonic rock. At least one or more kinds of rocks of obsidian, pearlstone, pitchstone and granite are accommodated in the rock accommodating container 16. Rhyolite such as obsidian, pearlstone or pitchstone, or granite is charged with minus electrons. Moreover, rhyolite such as obsidian, pearlstone or pitchstone and granite are acid rocks. Rhyolite has a same chemical composition as granite.

Of these igneous rocks, a rock including approximately 65 to 76 wt of silica dioxide (rhyolite such as obsidian, pearlstone or pitchstone, or plutonic rock such as granite) has an oxidation-reduction potential of −20 to −240 mV in raw state. Provided that a rock soluble in water is excluded from the rocks 54. The rock accommodating container 16 has, for example, an inner diameter set at 10 cm and a height of cylinder set at 80 cm, and of igneous rocks having a particle size of approximately 5 mm to 50 mm, the rock 54 including a large amount of silica dioxide is accommodated in the container 16 to an extent not to reduce a flow rate of water running therethrough.

When the water passed through the ion generator 14 is run through the rock accommodating container 16, e⁻ (minus electron) is added to the water. As a consequence, the chlorine (Cl) contained in city water is converted to a chlorine ion by the action of the minus electron.

Cl+e⁻→Cl⁻ (4)

This Cl⁻ and the aforementioned Na⁺ are, respectively, kept in stable ionic condition. The stable condition means that these ions are kept over a long time without evaporation. The hydroxyl ions (H₃O₂⁻) are also in stable ionic condition. By the passage of the water through the rock 54, hydronium ions (H₃O⁺) are more generated on comparison with the case of water being passed through the ion generator 14, along with hydroxyl ions (H₃O²⁻) and hydrogen ions (H⁺) being further generated.

H₂O+H⁺→H₃O⁺ (2)

H₃O⁺+H₂O→H₃O₂⁻+₂H⁺ (3)

The passage of water through the rock 54 brings about the following reactions other than those indicated above.

OH⁻+H⁺→H₂O (5)

₂H⁺+2e⁻→₂H₂ (6)

Moreover, when water is passed through the rock accommodating container 16, the oxidation-reduction potential of the water is changed from +340 mV to −20˜−240 mV by means of the minus electrons of the rock 54. Using hot water in place of water, the minus oxidation-reduction potential becomes more stabilized. The water passed through the rock 54 contains large amounts of dissolved oxygen and active hydrogen.

As shown in FIG. 1, a specific type of water (refreshed water) is one obtained by passing initially through an ion exchange resin, then through the tourmaline 46 (or a mixture of the tourmaline 46 and the metal 48) and finally through the rock accommodating container 16. The refreshed water contains Na⁺, Cl⁻, H⁺, OH⁻, H₂, hydronium ions (H₃O⁺), hydroxyl ions (H₃O₂⁻), active hydrogen and dissolved oxygen in large amounts. The water has an electromagnetic wave of a wavelength of 4˜14 Micrometers having an energy of 0.004 watts/cm² and has an oxidation-reduction potential of −20˜−240 mV.

As water used to produce the oil emulsion of the invention, there is used refreshed water obtained by passing water through the ion exchange resin 32, the tourmaline 46 (or a mixture of the tourmaline 46 and the metal 48) and the rock 54 in this order. Although water has been passed through the ion exchange resin 32, the tourmaline 46 (or a mixture of the tourmaline 46 and the metal 48) and the rock 54 in this order in FIG. 1, water may be passed through the ion exchange resin 32, the rock 54 and the tourmaline 46 (or a mixture of the tourmaline 46 and the metal 48) in this order. More particularly, as shown in FIG. 4, water may be passed through the first soft water generator 10, the second soft water generator 12, the rock accommodating container 16 and the ion generator 14 in this order.

In FIG. 4, water passed through the ion exchange resin 32 passes through the rock 54. e⁻ (minus electron) generates in the water by the action of the rock 54. As a consequence, the chlorine contained in city water is converted to a chlorine ion by means of the minus electrons.

Cl+e⁻→Cl⁻ (4)

The Cl⁻ and Na⁺ generated by means of the ion exchange resin 32, respectively, become ionically stabilized. It will be noted that the water passed through the ion exchange resin 32 may not contain Na⁺ in some case.

The water passed through the ion exchange resin 32 has H⁺, OH^{- and hydronium ions (H}₃O⁺) as shown in the formulas (1) and (2). When the water passed through the ion exchange resin 32 is further passed through the rock 54, the following reactions take place.

OH⁻+H⁺→H₂O (5)

H₂O+H⁺→H₃O⁺ (2)

₂H⁺+2e⁻→₂H₂ (6)

In these reactions, the hydronium ions (H₃O⁺) generate in amounts larger than those generated by means of the ion exchange resin 32.

As stated above, the passage of water through the rock 54 after the ion exchange resin 32 permits not only Na⁺ and OH⁻ originally existing in water, but also freshly generated Cl⁻ and hydronium ions (H₃O⁺) to exist in water. The water passed through the rock 54 has an oxidation-reduction potential of −20˜−240 mV. Using hot water in place of water, the minus oxidation-reduction potential becomes more stabilized. Moreover, the water passed through the rock 54 contains large amounts of dissolved oxygen and active hydrogen.

The water passed through the rock 54 is further passed through the ion generator 14 having the tourmaline 46 and the metal 48 therein. By this, the following reactions take place.

H₂O→H⁺+OH⁻ (1)

H₂O+H⁺→H₃O⁺ (2)

The hydronium ions (H₃O⁺) generate in large amounts. Part of the hydronium ions (H₃O⁺) is converted to hydroxyl ions (H₃O₂⁻).

H₃O⁺+H₂O→H₃O₂⁻+₂H⁺ (3)

As a consequence, the water passed through the tourmaline 46 and the metal 48 contains increased amounts of hydronium ions (H₃O⁺), hydroxyl ions (H₃O₂⁻), OH⁻, and H⁺.

As shown in FIG. 4, the water passed through the ion exchange resin 32, the rock 54 and the tourmaline 46 (or a mixture of the tourmaline 46 and the metal 48) in this order contains Na⁺, Cl⁻, OH⁻, hydronium ions (H₃O⁺), hydroxyl ions (H₃O₂⁻), H⁺, dissolved oxygen and active hydrogen and thus contains the same components as the refreshed water obtained in FIG. 1. Moreover, the water has an electromagnetic wave of 4˜14 micrometers having an energy of 0.004 watts/cm² and an oxidation-reduction potential of −20˜−240 mV. As a result, the water created with reference to FIG. 4 and the refreshed water created in FIG. 1 have the same effects. The water produced by use of the apparatus of FIG. 4 and the refreshed water produced in FIG. 1 eventually have the same components therein. Thus, the water produced by use of the apparatus or FIG. 4 is also called refreshed water.

The results of quality inspection, of the refreshed water are as follows. The values for city water are indicated in parentheses for comparison with the refreshed water provided that the values of city water same as those of the refreshed water are indicated as “same”. The nitrous acid-derived nitrogen and nitric acid-derived nitrogen; 1.8 mg/l (same), chlorine ion 6.8 mg/l (9.0 mg/l), general bacteria: 0/ml (same), cyan ion: less than 0.01 mg/l (same), mercury: less than 0.0005 mg/l (same), organic phosphorus: less than 0.1 mg/l (same), copper: less than 0.01 mg/l (same), iron: less than 0.05 mg/l (less than 0.08 mg/l), manganese: less than 0.01 mg/l (same), zinc: less than 0.005 mg/l (less than 0.054 mg/l), lead: less than 0.01 mg/l (same), hexavalent chromium: less than 0.02 mg/l (same), cadmium: less than 0.005 mg/l (same), arsenic: less than 0.005 mg/l (same), fluorine: less than 0.15 mg/l (same), calcium, magnesium, etc. (hardness): 1.2 mg/l (49.0 mg/l), phenols: less than 0.005 mg/l (same), anionic surface active agent: less than 0.2 mg/l (same), pH value: 6.9 (same), odor: no offensive odor (same), taste: no abnormal taste (same), chromaticity: 2 degrees (same), and turbidity: 0 degree (one degree).

The refreshed water is characterized in many respects as listed below.

(a) Hydronium ion (H₃O⁺), hydroxyl ion (H₃O₂⁻), hydrogen ion (H⁺), hydrogen, hydroxyl group (OH⁻), Sulfate ion (SO₄²⁻), hydrogen bicarbonate ion (HCO₃⁻), carbonate ion (CO₃₂⁻), metasilicic acid (H₂SiO₃), and free carbon dioxide (CO₂) are contained.
(b) Surface active effect is exerted.
Surface active effect (emulsification of OW type refreshed water) is exerted.
(c) Weak energy (growth light) effect is exerted.
Tourmaline emits a weak energy (electromagnetic wave at a wavelength of 4 to 14 microns). The weak energy cuts a large cluster of water to discharge a toxic gas and a heavy metal held in the cluster to outside of the water.
(d) Oxidation-reduction potential of −20 to −240 mV.
(e) Dissolved oxygen and active hydrogen are included.
(f) Soft water removed of calcium ion and aluminium ion.
Calcium ion and aluminium ion included in water can be removed from city water by passing through an ion exchange resin.
(g) Active hydrogen bicarbonate (HCO₃⁻) and metasilicic acid (H₂SiO₃) are included.

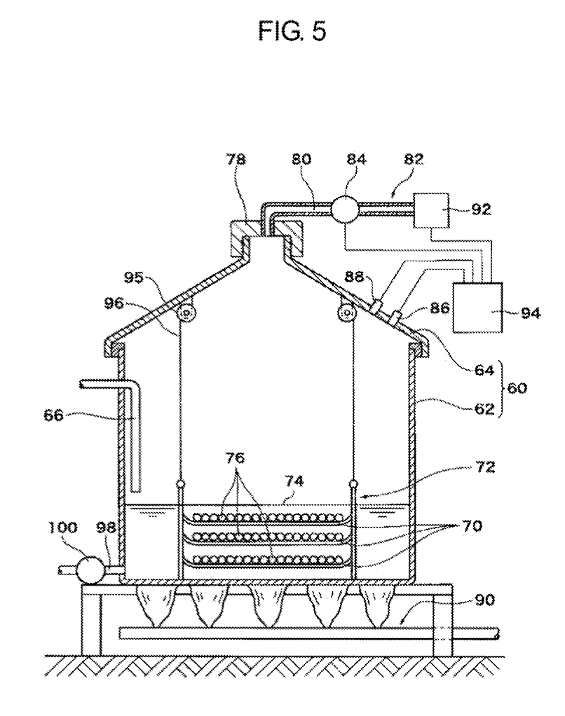

Next, a method for producing hydrogen according to the invention will be described with reference to FIG. 5. In a method for producing hydrogen according to the invention, hydrogen is produced by using water, aluminium and either of sodium bicarbonate or sodium carbonate. In a method for producing hydrogen according to the invention, a container 60 is used to contain water, aluminium and either of sodium bicarbonate or sodium carbonate therein. The container 60 comprises a body 62 and a lid 64. Materials to be used for various containers at home such as glass or stainless steel can be used as a material for the container 60. More particularly, in the invention, a specific material may not be used for the container 60. The container 60 is provided with an aqueous solution introducing tube 66 for supplying an aqueous sodium bicarbonate solution or an aqueous sodium carbonate solution from the outside to the inside of the container 60 so that the aqueous solution can be appropriately introduced into the container 60 from the outside through the aqueous solution introducing tube 68.

The container 60 is provided with an aluminium accommodation means 72 having one or more shelves 70, on which a large number of masses of aluminium 76 are placed. More particularly, the accommodation means 72 contains a large number of masses of aluminium 76 therein. The masses of aluminium, for example, having a diameter of 4 to 5 mm or larger and those having a plate-shape are included therein. In the case of generating a hydrogen gas, the mass of aluminium 76 is set to be positioned under a liquid surface 74 in the container 60. The accommodation means 72 is arranged to be freely taken out or placed in the container 60 by removing the lid 64 from the body 62. A number of small holes (not shown) through which water passes vertically are formed on the shelf 70. A mesh having pores or a punching board through which a number of small holes are formed is used as the shelf 70. The size of the mass of aluminium 76 placed on the shelf 70 is set to be larger than a small holes formed in the shelf 70.

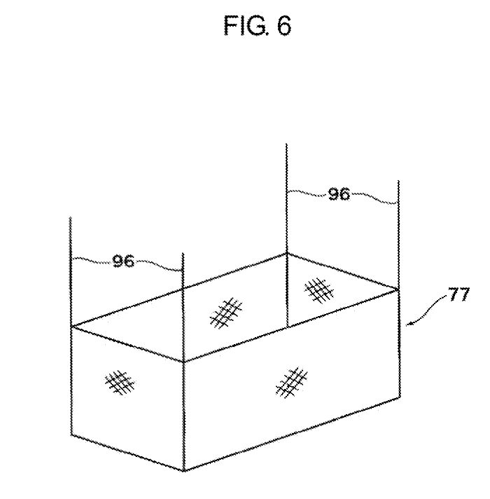

Not only limited to a mass, but a small particle or powder of aluminium can also be used. When a small particle or powder of aluminium is used, a meshed or metal accommodation means 77 shaped as a small container in which a number of very small diameter holes are provided (shown in FIG. 6) is used. The small particle or powder of aluminium is placed in the accommodation means 77, and then, the accommodation means is placed in the container 60. Water can move inside and outside the accommodation means 77 through a number of small diameter holes formed therein, but the holes formed in accommodation means 77 are set to a size that a small particle or powder of aluminium is not easily passed therethrough. It will be noted that a mass of aluminium may be placed in the accommodation means 77. When the accommodation means 75 is provided in the container 60, aluminium placed in the accommodation means 77 is set under the liquid surface 74. In the invention, any type of commercial aluminium available from any manufacturer may be used.

A cap 78 is attached to a top end of the lid 64. A gas drawing nozzle 82 inside of which connection path 80 for connecting inside and outside of the container 60 is formed is attached to the cap 78. An on-off valve 84, which opens and closes the connection path 80 to draw hydrogen generated in the container 60 outside, is provided in the middle of the gas drawing nozzle 82. In a condition that the on-off valve 84 is closed, the inside of the container 60 is set to be hermetically sealed by closing the upper opening of the body 62 by using the lid 64 provided with the cap 78. A barometer 86 for measuring an air pressure inside of the container 60 and a thermometer 88 for measuring a temperature inside of the container 60 is attached to either of the upper part of the body 62 or the lid 64 in the container 60. The lid 64 should be preferably made in a conical or pyramidal shape so that a horizontal section thereof is gradually narrowed toward the upper center portion (Cap 78). This is because generated low specific gravity hydrogen is collected in the upper part of container 60 so that hydrogen can be easily drawn out of the container 60 via the nozzle 82.

A heating means 90 for heating water in the container 60 is provided in the lower part of the container 60, wherein water is heated by the heating means 90. A position to which the heating means 90 is provided is not limited to the lower part of the container 60. It will be noted that the heating means 90 is not limited to a heating power such as gas, kerosene or the like, but may be sunlight or an electric heater. A heating means used in the invention may be produced by feeding a sodium hydroxide into the container 60 so that the inside thereof is further heated through a chemical reaction.

A hydrogen amount detector 92 for measuring an amount of hydrogen drawn out from the container 60 is provided in the tip end at the outer side of the gas drawing nozzle 82. The amount of hydrogen detected by the hydrogen amount detector 92 is input to a computer 94. Additionally, a pressure in the container 60 detected by a barometer 86 and a temperature in the container 60 detected by the thermometer 88 is input to the computer 94. The computer 94 operates and controls the heating means 90 to heat water in the container 60, and also, opens and closes the on-off valve 84 to draw hydrogen outside from the container 60.

An elevation means 95 such as a pulley operated by the computer 94 is provided the back surface of the lid 64, and the elevation means 95 and the accommodation means 72 and 77 are connected by a connection means 96 such as a wire. The elevation means 95 raises or lowers the accommodation means 72 and 77 so that aluminium 76 contained in the accommodation means 72 and 77 are immersed under or raised above the liquid surface 74. It is noted that, in the container 60 shown in FIG. 5, the elevation means 95 is provided to the lid 62, but in an alternate way, the body 62 may be formed integrally with the upper ceiling so that the elevation means 95 is attached to the upper ceiling of the body 62. In this configuration, a lid is attached to the side of the body 62. A discharge pipe 98 is attached to the lower part of the container 60 to discharge water (aqueous sodium bicarbonate solution or aqueous sodium carbonate solution) outside the container 60, and an on-off valve 100 is provided in the middle of the discharge pipe 98.

In the invention, water and aluminium 76 and either of sodium bicarbonate or sodium carbonate, is fed into the container 60, and then water (aqueous sodium bicarbonate solution or aqueous sodium carbonate solution) in the container 60 is heated by a heating means. A heating temperature of the water is set at 60° C. or higher to the evaporation temperature of the water. A generation amount of hydrogen is extremely reduced at a temperature below 60° C. When the aluminium 76 is immersed under the liquid surface 74 in the container 60, if the water is heated to the optimal heating temperature of 86° C. to 97° C., the amount of hydrogen generation is increased, and besides, not only hydrogen but also a water vapor is filled in the container 60, and thus, the water in the container 60 should not preferably be heated to the evaporation temperature. The water may preferably be heated to the evaporating temperature of aqueous solution in some cases, and a case where an aqueous solution is heated to the evaporation temperature will be described later.

Here, a ratio of weight of water, aluminium 76 and either of sodium bicarbonate or sodium carbonate in the invention will be described later. First, when a weight of water to be fed into the container 60 is set to 100 wt (e.g., 100 g), a weight of aluminium to be fed into the container 60 is set to not less than 1 wt (not less than 1 g). When the weight of aluminium is less than 1 wt (less than 1 g), a generation amount of hydrogen is reduced, thus not being suited for a practical use. In the invention, the most preferable weight range of aluminium is 10 wt or more. If the weight of aluminium is less than 10 wt, the generation amount of hydrogen is smaller than when the most preferable weight range of aluminium is used. If the weight of aluminium is more than 30 wt, the generation amount of hydrogen is not changed as when 30 wt of aluminium is used, but the cost and weight of aluminium are increased, thus indicating that the weight of aluminium should be preferably 10 wt to 30 wt.

Either of sodium bicarbonate or sodium carbonates is fed into the container 60. Provided that a mixture of sodium bicarbonate and sodium carbonate (at least one of sodium bicarbonate or sodium carbonate) may be used. A weight of sodium bicarbonate or sodium carbonate to be fed into the container 60 is set at not less than 1 wt. relative to 100 wt of water. If the weight of sodium bicarbonate or sodium carbonate is less than 1 wt, hydrogen is still generated but in a reduced amount, thus not being suited for a practical use. On the other hand, if the weight of sodium bicarbonate or sodium carbonate is more than 30 wt, the solubility of sodium bicarbonate or sodium carbonate to water is deteriorated and besides causing a cost increase. Thus, from the viewpoint of cost, the most preferable weight range of sodium bicarbonate or sodium carbonate should be preferably from 10 wt to 30 wt. If the weight of sodium bicarbonate or sodium carbonate is less than 10 wt, the generation amount of hydrogen is smaller than when the most preferable weight range of sodium bicarbonate or sodium carbonate is used. On the other hand, if the weight of sodium bicarbonate or sodium carbonate is more than 30 wt, the generation amount of hydrogen is not changed as when 10 wt. to 30 wt of sodium bicarbonate or sodium carbonate is used, but the cost of sodium bicarbonate or sodium carbonate is increased.

As water used in the invention, in addition to the above-mentioned refreshed water, various types of water such as purified water, hydrogen water (water containing, for example, 0.2 ppm of hydrogen therein) or city water may be used. It is noted that, water or city water used as a base of the refreshed water is city water supplied in Ueda City, Nagano Prefecture.

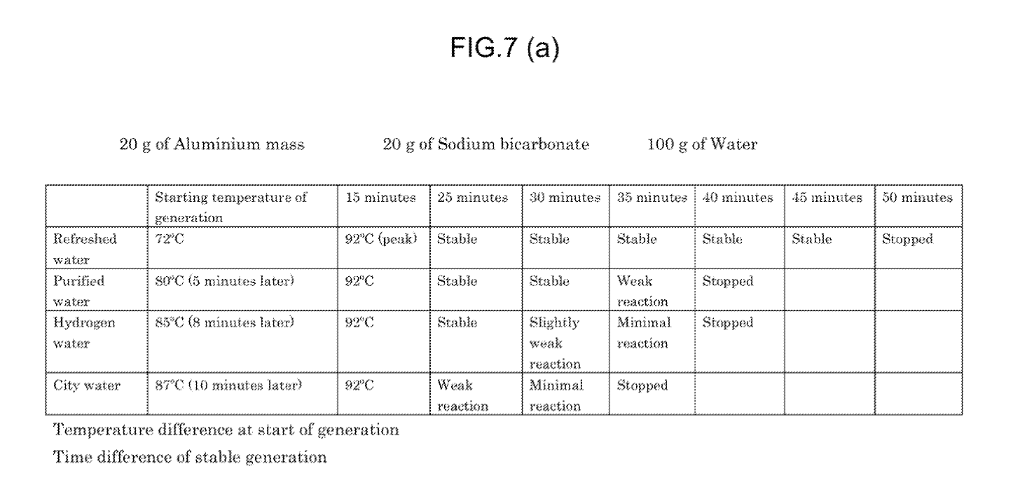

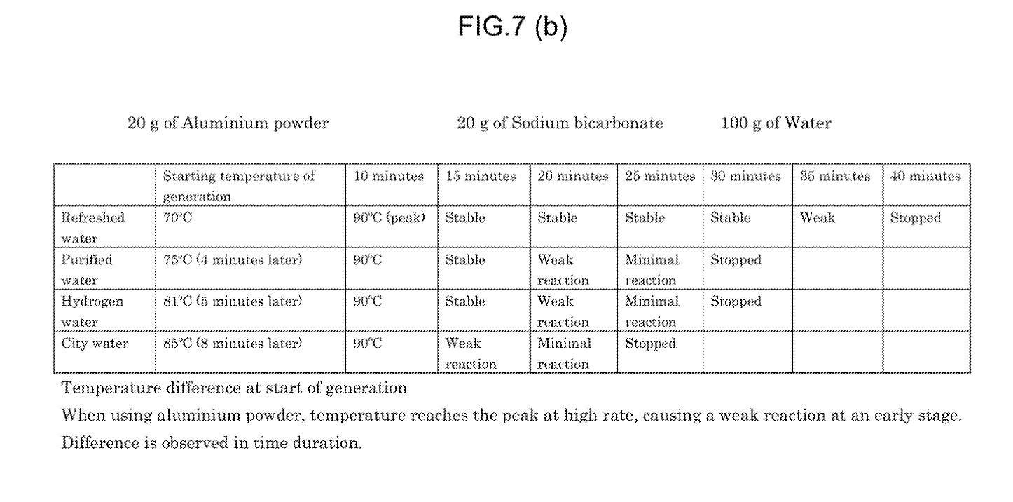

Then, an experiment was conducted to determine a time of hydrogen generation when water, aluminium 76 and sodium bicarbonate were used. The tables of experimental results are shown in FIG. 7. FIG. 7 shows a result in which “sodium bicarbonate” was used from either of “sodium bicarbonate or sodium carbonate”. A weight of water to be fed into the container 60 was set at 100 wt, a weight of aluminium to be fed into the container 60 is set at 20 wt, and a weight of sodium bicarbonate is set at 20 wt to conduct an experiment for determining a time of hydrogen generation by using the above-descried four types of water (refreshed water, purified water, hydrogen water and city water). It is noted that, a table listing a result of when aluminium 76 is used as a “mass” is shown in FIG. 7(a), and a table listing a result of when aluminium 76 is used as a “powder” is shown in FIG. 7(b).

In FIG. 7(a), since aluminium is used as a “mass”, a large number of masses of aluminium 76 are placed on a plurality of shelves 70 in the accommodation means 72, all the masses of aluminium 76 contained in the accommodation means 72 are immersed under the liquid surface 74 by operating the elevation means 95. Besides the aluminium 76, water and sodium bicarbonate are fed into the container 60.

After water, a mass of aluminium and sodium bicarbonate are fed into the container 60, the four types of water are heated respectively from a staring temperature (the starting temperature is appropriately set between 72° C. and 87° C.) by using the heating means 90. Th±e four types of water are heated respectively by using the heating means 90 such that they reach a same peak temperature of 92° C. 15 minutes after start of heating. As a temperature of water in the container 60 is raised, a temperature inside of the container 60 is raised and a generation amount of hydrogen is increased. A peak temperature refers to a temperature at which generation of hydrogen per unit of time is maximum. In this case, although a peak temperature was set at 92° C. (same temperature), the peak temperature is not only limited to a specific temperature such as 92° C. but varied, for example, approximately 92° C.±4° C. depending on a condition such as room temperature or the like.

After reaching a peak temperature, water in the container 60 is heated and kept to the peak temperature (within the peak temperature range) by appropriately operating the heating means 90. More particularly, the heating means 90 is a heating and warm keeping means for keeping an aqueous solution in the container 60 to a peak temperature at which generation amount of hydrogen is approximately maximum by the combination of weight of aluminium, weight of sodium bicarbonate and type of water.

When using refreshed water, after reaching a peak temperature (15 minutes after start of reaction), a similar stable condition as observed at the time of peak temperature continued for 30 minutes (until 45 minutes after start of reaction), and thereafter generation of hydrogen stopped in approximately 5 minutes. Herein, “stability” in FIG. 7(a) refers that a temperature within the container 60 is kept at the peak temperature and a generation amount of hydrogen per unit time is approximately maximum (approximately constant). On the other hand, when using purified water, after reaching a peak temperature, a similar stable condition as observed at the time of peak temperature continued for 15 minutes (until 30 minutes after start of reaction), subsequently a weak reaction continued for approximately 5 minutes, and thereafter generation of hydrogen stopped in approximately 5 minutes. “A weak reaction” refers that a generation amount of hydrogen in a reaction is reduced to a level lower than (an approximately half amount of) those observed in “a stable state”. When using hydrogen water, after reaching a peak temperature, a similar stable condition as observed at the time of peak temperature continued for 10 minutes (until 25 minutes after start of reaction), subsequently “a slightly weak reaction” continued for approximately 5 minutes, then “a minimal reaction” continued for approximately 5 minutes, and thereafter generation of hydrogen stopped in approximately it minutes, “A slightly weak reaction” refers that a generation amount of hydrogen in a reaction is reduced to a level between those observed in “a stable state” and “a weak reaction”, and “a minimal reaction” refers that a generation amount of hydrogen in a reaction is reduced to an approximately half or lower level of those observed in “a weak reaction”. When using city water, after reaching a peak temperature, hydrogen was generated in a weak reaction for about 10 minutes (until 25 minutes after start of reaction), and then it continued for about 5 minutes (until 30 minutes after start of reaction) in a minimal reaction, and thereafter generation of hydrogen stopped in approximately 5 minutes.

FIG. 7(b) is a result of experiment in which aluminium is used as a “powder”. More particularly, FIG. 7(b) is a result of experiment showing a time of hydrogen generation in four of refreshed water, purified water, hydrogen water and city water when using 100 wt of water, 20 wt of aluminium powder and 20 wt of sodium bicarbonate. Since aluminium is used as a “powder”, the aluminium powder is fed to the inside of the accommodation means 77, and then immersed under the liquid surface 74 in the container 60.

After water, an aluminium powder and sodium bicarbonate are fed into the container 60, the four types of water are heated respectively from a starting temperature (the starting temperature is appropriately set between 70° C. and 85° C.) by using the heating means 90. Since temperatures of the four types of water at the start of experiment are 60° C. or higher, hydrogen is generated from the start of experiment in the each water. The generation amount of hydrogen is increased as a temperature of water in the container 60 rises. Thereafter, water in the container 60 is heated until the water reaches its peak temperature by using the heating means 90. In this case, although the peak temperature was set at 90° C., the peak temperature is not only limited to a specific temperature such as 90° C. but varied, for example, in a range of approximately 90° C.±4° C. depending on a condition such as room temperature or the like.

FIG. 7(b) is an experimental result showing a time of hydrogen generation in four of refreshed water, purified water, hydrogen water and city water, under a condition that 100 wt of water, 20 wt of aluminium powder and 20 wt of sodium bicarbonate are mixed. The four types of water are heated respectively such that they reach a peak temperature of 90° C. (same temperature) (10 minutes after start of hydrogen generation). When using refreshed water, after reaching a peak temperature, a similar stable condition as observed at the time of peak temperature continued for 20 minutes (until 30 minutes after start of reaction), subsequently a weak reaction continued for 5 minutes, and thereafter generation of hydrogen stopped in approximately 5 minutes. When using purified water, after reaching a peak temperature, a similar stable condition as observed at the time of peak temperature continued for 5 minutes (until 15 minutes after start of reaction), subsequently a weak reaction continued for 5 minutes (until 20 minutes after start of reaction), then a minimal reaction continued for 5 minutes (until 25 minutes after start of reaction), and thereafter generation of hydrogen stopped in approximately 5 minutes. When using hydrogen water, after reaching a peak temperature, a similar stable condition as observed at the time of peak temperature continued for 5 minutes (until 15 minutes after start of reaction), subsequently hydrogen was generated by a weak reaction continued for approximately 5 minutes (until 20 minutes after start of reaction), then a minimal reaction continued for 5 minutes (until 25 minutes after start of reaction), and thereafter generation of hydrogen stopped in approximately 5 minutes. When using city water, after reaching a peak temperature, a weak reaction continued for approximately 5 minutes (until 15 minutes after start of reaction), then a minimal reaction continued for 5 minutes (until 20 minutes after start of reaction), and thereafter generation of hydrogen stopped in approximately 5 minutes.

In the case of using “sodium bicarbonate” as shown in FIG. 7, a similar stable condition as observed at the time of peak temperature continues for the longest time as compared with other three of the four types of water (purified water, hydrogen water, city water), even if aluminium is used either as a mass or as a powder. Moreover, when “sodium bicarbonate” is used, a “mass” of aluminium generates hydrogen for a time longer than a “powder” of aluminium. It is apparent from the fact that hydrogen was generated stably until 45 minutes after start of reaction in the refreshed water when using a mass of aluminium shown in FIG. 7(a), whereas hydrogen was generated stably until 30 minutes after start of reaction in the refreshed water when using a powder of aluminium shown in FIG. 7(b).

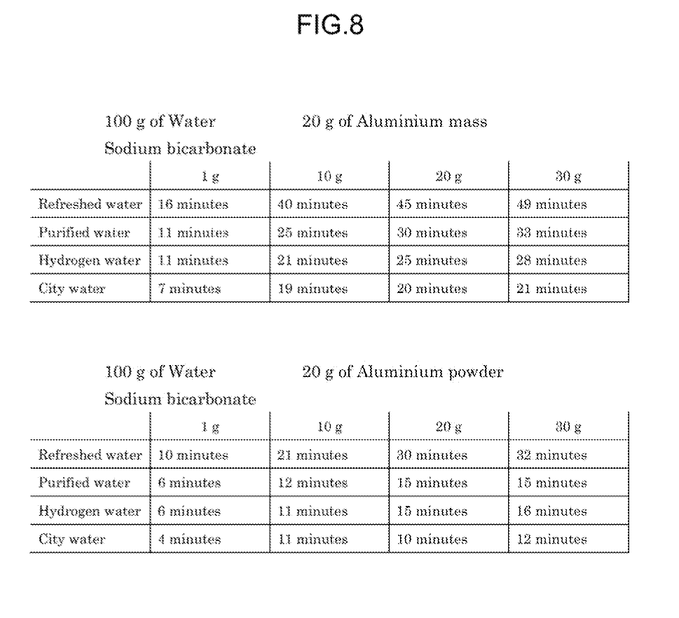

FIG. 8 shows a result of experiment in which 100 wt of water (refreshed water, purified water, hydrogen water or city water) and 20 wt of aluminium (as a “mass” or a “powder”) are used to determine a change in time of hydrogen generation associated with the change in weight of “sodium bicarbonate”. In all of the four types of water of refreshed water, purified water, hydrogen water and city water, when the weight of “sodium bicarbonate” is 1 wt, hydrogen is generated for 4 to 16 minutes (a range between the shortest and the longest time during which hydrogen is generated in the four types of water shown in a table of FIG. 8). In this case, when refreshed water is used, if an aluminium mass is used, hydrogen is generated for 16 minutes, whereas if aluminium powder is used, hydrogen is generated for 10 minutes. More particularly, when the weight of “sodium carbonate” is 1 wt, if refreshed water and 1 wt of aluminium are used, a time of hydrogen generation is longer than in the case where the other three types of water are used.

When the weight of “sodium bicarbonate” is 1.0 wt, hydrogen is generated for 11 to 40 minutes (a range between the shortest and the longest time during which hydrogen is generated in the four types of water shown in a table of FIG. 8). In this case, when refreshed water is used, if an aluminium mass is used, hydrogen is generated for 40 minutes, whereas if an aluminium powder is used, hydrogen is generated for 21 minutes. More particularly, when the weight of “sodium bicarbonate” is 10 wt, if refreshed water and an aluminium mass are used, hydrogen is generated for the longest time. Then, when the weight of “sodium bicarbonate” is 20 wt, hydrogen is generated for 10 to 45 minutes. In this case, when refreshed water is used, if an aluminium mass is used, hydrogen is generated for 45 minutes, whereas if an aluminium powder is used, hydrogen is generated for 30 minutes. More particularly, when the weight of “sodium bicarbonate” is 20 wt, if refreshed water and an aluminium mass are used, hydrogen is generated for the longest time. Then, when the weight of “sodium bicarbonate” is 30 wt, hydrogen is generated for 12 to 47 minutes. In this case, when refreshed water is used, if an aluminium mass is used, hydrogen is generated for 45 minutes, whereas if an aluminium powder is used, hydrogen is generated for 30 minutes. More particularly, when the weight of “sodium bicarbonate” is 20 wt, if refreshed water and an aluminium mass are used, hydrogen is generated for the longest time.

When the weight range of “sodium bicarbonate” is 10 wt to 30 wt, it is apparent that a time of hydrogen generation is longer than the case of using 1 wt of “sodium bicarbonate” in all of the four of refreshed water, purified water, hydrogen water and city water. Furthermore, as shown in FIG. 8, among the four types of water, a time of hydrogen generation is longer especially when using the refreshed water in all of the cases where “sodium bicarbonate” is used at 1 wt, 10 wt, 20 wt and 30 wt, as compared with other three types of water. Moreover, it is apparent that if aluminium is used as a “mass”, the time of hydrogen generation is about 1.5 to 2 times longer than the case where aluminium is used as a “powder”, and therefore, aluminium should be preferably used as a “mass” rather than as a “powder” in the invention.

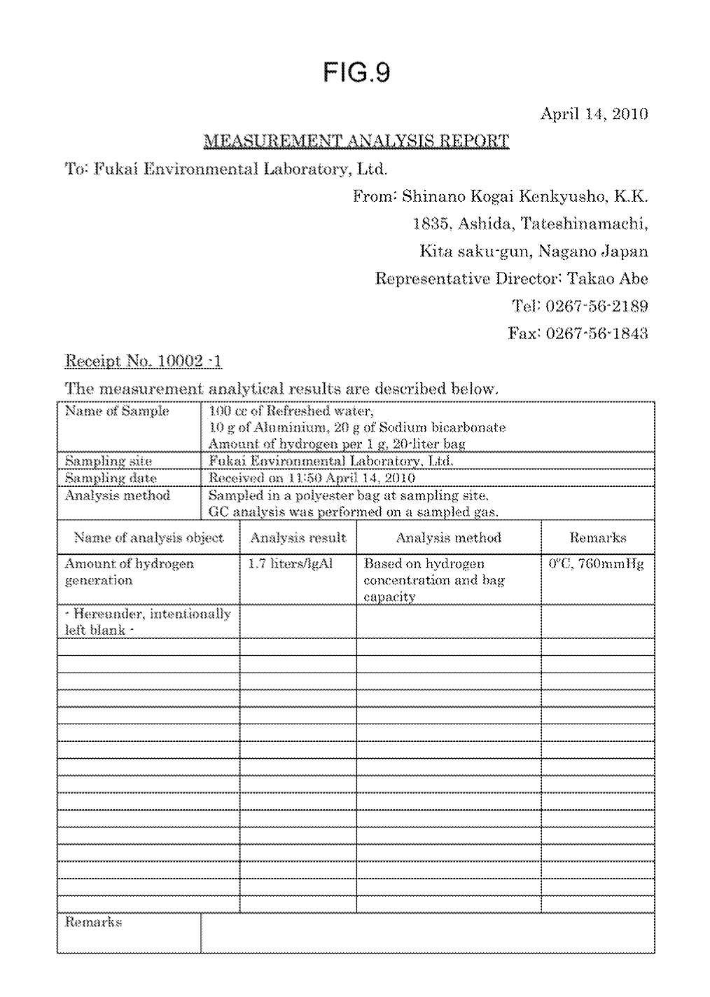

An experiment was performed to determine how much hydrogen is generated per 1 g of aluminium by using water, aluminium and sodium bicarbonate. To ensure the objectivity in the generation amount of hydrogen, the measurement analysis was entrusted to the third organization. A measurement analysis report, which shows results of the experimental analysis, is given in FIG. 9. The measurement analysis report was made by Shinano Kogai Kenkyusho, KK, (Tel: 0267-56-2189) located at 1835, Ashida, Tateshinamachi, Saku-gun, Nagano Japan on Apr. 14, 2010. The experiment was performed by using 100 cc of refreshed water by adding 15 g of aluminium and 20 g of sodium bicarbonate thereto. As a result of the experiment, 1.7 liters of hydrogen per 1g of aluminium was obtained.

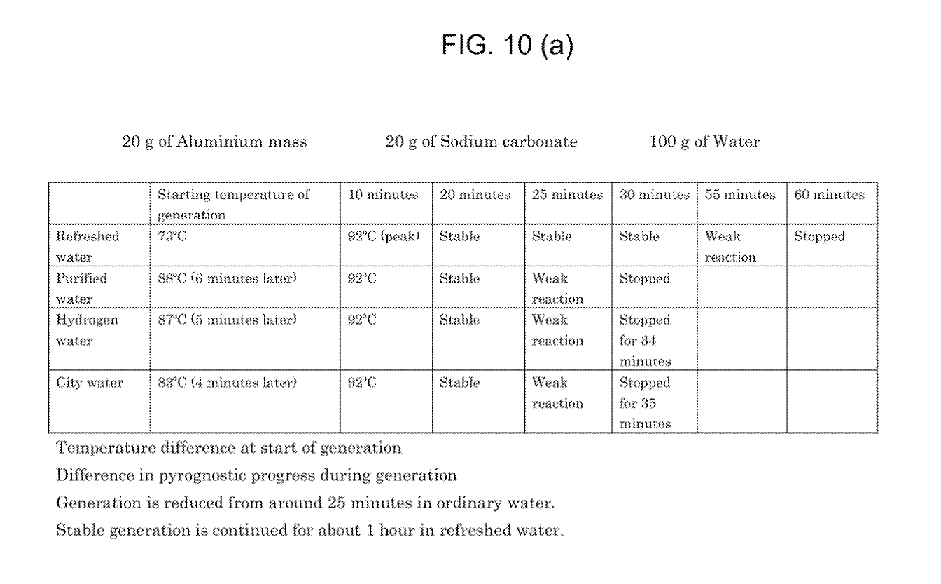

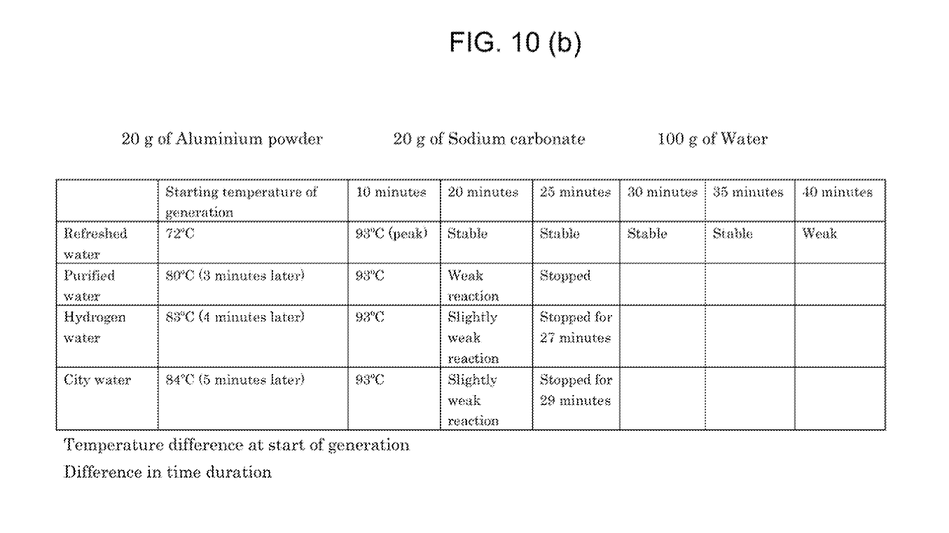

Then, an experiment was performed to determine how much hydrogen is generated by mixing water, aluminium 76 and “sodium carbonate”. The tables of the experimental results are shown in FIG. 10. FIG. 10 shows a result in which “sodium carbonate” was used from either of “sodium bicarbonate or sodium carbonate”. A weight of water to be fed into the container 60 is set at 100 wt (100 cc), a weight of aluminium to be fed into the container 60 is set at 20 wt (20 g), and a weight of sodium carbonate was set at 20 wt (20 g) to conduct an experiment for determining a time of hydrogen generation by using the four types of water (refreshed water, purified water, hydrogen water and city water). It is noted that, results obtained by using a “mass” of aluminium 76 is shown in FIG. 10(a), and those obtained by using a “powder” of aluminium 76 is shown in FIG. 10(b).

In FIG. 10(a), since aluminium is used as a “mass”, a large number of masses of aluminium 70 are placed on a plurality of shelves 70 in the accommodation means 72, all the masses of aluminium 76 contained in the accommodation means 72 are immersed under the liquid surface 74 by operating the elevation means 95. Besides the aluminium 76, water and sodium carbonate are fed into the container 60.

Water, an aluminium mass and sodium carbonate are fed into the container 60, and then, the four types of water are heated respectively from a starting temperature (the starting temperature is appropriately set between 72° C. and 87° C.) by using the heating means 90. The four types of water are heated respectively by using the heating means, 90 such that they reach a same peak temperature of 92° C. 10 minutes after start of heating. As a temperature of the water in the container 60 is raised, a temperature inside of the container 60 is raised and a generation amount of hydrogen is increased. Although the peak temperature was set at 92° C., the peak temperature may be, for example, in a range of approximately 92° C.±4° C.

After reaching a peak temperature, keep a temperature inside of the container 60 at or around the peak temperature by using the heating means 90. When using refreshed water, after reaching a peak temperature, a similar stable condition as observed at the time of peak temperature continued for 20 minutes (until 30 minutes after start of reaction), subsequently a weak reaction continued for 25 minutes (until 55 minutes after start of reaction), and thereafter generation of hydrogen stopped in approximately 5 minutes. When using purified water, after reaching a peak temperature, a similar stable condition as observed at the time of peak temperature continued for 10 minutes (until 20 minutes after start of reaction), subsequently a weak reaction continued for approximately 5 minutes, and thereafter generation of hydrogen stopped in approximately 5 minutes. When using hydrogen water, after reaching a peak temperature, a similar stable condition as observed at the time of peak temperature continued for 10 minutes (until 20 minutes after start of reaction), subsequently a weak reaction continued for approximately 5 minutes, and thereafter generation of hydrogen stopped in 9 minutes. When using city water, after reaching a peak temperature, a similar stable condition as observed at the time of peak temperature continued for 10 minutes (until 20 minutes after start of reaction), subsequently hydrogen was generated by a weak reaction continuously for 5 minutes (until approximately 25 minutes after start of reaction), and thereafter generation of hydrogen stopped in 10 minutes.

FIG. 10(b) is a result of experiment in which aluminium is used as a “powder”. More particularly, FIG. 10(b) is a result of experiment showing a time at which hydrogen is generated in four of refreshed water, purified water, hydrogen water and city water when using 100 wt of water, 20 wt of aluminium powder and 20 wt of sodium carbonate. Since aluminium is used as a “powder”, the aluminium powder is fed to the inside of the accommodation means 77, and then immersed under the liquid surface 74 in the container 60.

Water, an aluminium powder and sodium carbonate are fed into the container 60, and then, the four types of water are heated respectively from a starting temperature (the starting temperature is appropriately set between 72° C. and 84° C.) by using the heating means 90. Since temperatures of the four types of water at the start of experiment are 60° C. or higher, hydrogen is generated from the start of experiment in the each water. Then, the water in the container 60 is heated for 10 minutes by using the heating means 90 such that the temperature of the water becomes the peak temperature (93° C.). Although the peak temperature was set at 93° C., the peak temperature is not only limited to a specific temperature such as 93° C., but varied, for example, in a range of approximately 93° C.±4° C. depending on a condition such as room temperature or the like.

FIG. 10(b) is an experimental result showing a time at which hydrogen is generated in four of refreshed water, purified water, hydrogen water and city water, under a condition that 100 wt of water, 20 wt of aluminium powder and 20 wt of sodium bicarbonate are mixed. The four types of water are heated such that they reach a peak temperature (same temperature) of 93° C. (10 minutes after start of hydrogen generation). When using refreshed water, after reaching a peak temperature, a similar stable condition as observed at the time of peak temperature continued for 25 minutes (until 35 minutes after start of reaction), and subsequently a weak reaction continued for approximately 5 minutes. Although not shown in the table, generation of hydrogen stopped in approximately 45 minutes. When using purified water, after reaching a peak temperature, a weak reaction continued for 10 minutes (until 20 minutes after start of reaction), and then generation of hydrogen stopped in approximately 5 minutes. When using hydrogen water, after reaching a peak temperature, hydrogen is generated in a slightly weak reaction for about 10 minutes (until 20 minutes after start of reaction), and then generation of hydrogen stopped in 7 minutes (27 minutes after start of reaction). When using city water, after reaching a peak temperature, hydrogen is generated in a slightly weak reaction for about 10 minutes (until 20 minutes after start of reaction), and then generation of hydrogen stopped in 9 minutes (29 minutes after start of reaction).

In the case of using “sodium carbonate” shown in FIG. 10, a similar stable condition as observed at the time of peak temperature was continued for the longest time in the refreshed water as compared with other three of the four types of water. Moreover, when “sodium carbonate” is used, “mass” of aluminium generates hydrogen for a time longer than “powder” of aluminium. It is apparent from the fact that hydrogen was generated stably until 55 minutes in the refreshed water when using a mass of aluminium shown in FIG. 10(a), whereas generation of hydrogen stopped until around 45 minutes in the refreshed water when using a powder of aluminium shown in FIG. 10(b). Moreover, it is apparent from the fact that, even in a comparison between the three of purified water, hydrogen water and city water shown in FIG. 10(a) and those shown in FIG. 10(b), time of hydrogen generation in FIG. 10(a) is longer than those in FIG. 10(b), in all the three types of water.

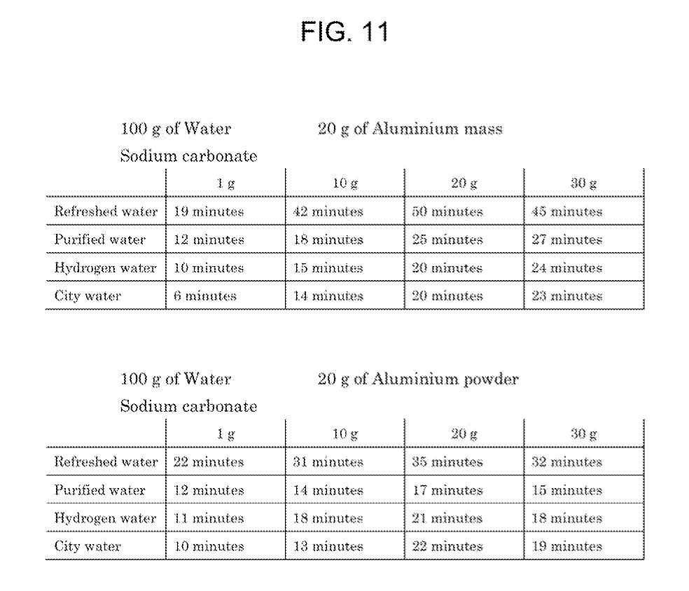

FIG. 11 shows a result of experiment in which 100 wt of water (refreshed water, purified water, hydrogen water or city water) and 20 wt of aluminium (as a “mass” or a “powder”) are used to determine a change in time of hydrogen generation associated with a change in weight of “sodium carbonate”. In all of the four of refreshed water, purified water, hydrogen water and city water, when the weight of “sodium carbonate” is 1 wt, hydrogen is generated for 6 to 16 minutes (a range between the shortest and the longest time during which hydrogen is generated in the four types of water shown in a table of FIG. 11). In this case, when refreshed water is used, if an aluminium mass is used, hydrogen is generated for 19 minutes, whereas if an aluminium powder is used, hydrogen is generated for 22 minutes. More particularly, when the weight of “sodium carbonate” is 1 wt, if refreshed water and aluminium are used, a time of hydrogen generation is longer than in the case where the other three types of water are used.

When the weight of “sodium carbonate” is 10 wt, hydrogen is generated for 13 to 42 minutes (a range between the shortest and the longest time during which hydrogen is generated in the four types of water shown in a table of FIG. 11). In this case, when refreshed water is used, if an aluminium mass is used, hydrogen is generated for 42 minutes, whereas if an aluminium powder is used, hydrogen is generated for 31 minutes More particularly, when the weight of “sodium carbonate” is 10 wt, if refreshed water and an aluminium mass are used, hydrogen is generated for the longest time. Then, when the weight of “sodium carbonate” is 20 wt, hydrogen is generated for 17 to 50 minutes. In this case, when refreshed water is used, if an aluminium mass is used, hydrogen is generated for 50 minutes, whereas if an aluminium powder is used, hydrogen is generated for 35 minutes. More particularly, when the weight of “sodium bicarbonate” is 20 wt, if refreshed water and an aluminium mass are used, hydrogen is generated for the longest time. Then, when the weight of “sodium carbonate” is 30 wt, hydrogen is generated for 15 to 45 minutes. In this case, when refreshed water is used, if an aluminium mass is used, hydrogen is generated for 45 minutes, whereas if an aluminium powder is used, hydrogen is generated for 32 minutes. More particularly, when the weight of “sodium carbonate” is 30 wt, if refreshed water and an aluminium mass are used, hydrogen is generated for the longest time.

More particularly, when the weight range of “sodium carbonate” is 10 wt to 30 wt, it is apparent that a time of hydrogen generation is longer than the case where the weight of “sodium carbonate” is 1 wt in all of the four of refreshed water, purified water, hydrogen water and city water. Furthermore, as shown in FIG. 11, among the four types of water, a time of hydrogen generation is longer especially when using the refreshed water in all of the cases where “sodium carbonate” is used at 1 wt, 10 wt, 20 wt and 30 wt, as compared with other three types of water. Moreover, it is apparent that if aluminium is used as a “mass”, the time of hydrogen generation is about 1.5 times longer than the case where aluminium is used as a “powder”, and therefore, aluminium should be preferably used as a “mass” rather than as a “powder” in the invention.

Hydrogen generated in the container 60 increases a pressure in the container 60. Moreover, also when water in the container 60 is evaporated, a pressure in the container 60 is increased. When a pressure in the container 60 is increased, the on-off valve 84 is opened on an assumption that hydrogen is generated in the container 60. When the on-off valve 84 is opened, a high temperature and pressure gas (including not only hydrogen but also a vapor mixed therewith) in the container 60 are drawn outward therefrom through the nozzle 82. Since the vapor becomes water after cooled, hydrogen alone can be collected efficiently. Sodium aluminate can be obtained as a residue in the container 60 by using either sodium bicarbonate or sodium carbonate. The sodium aluminate thus obtained can be used for various purposes.

It is apparent that a larger amount of hydrogen is generated when the aluminium 76 is used as a “mass” rather than a “powder” from a result concerning the time of hydrogen generation shown in FIGS. 7 to 11 where aluminium 76 is used as a “mass” or a “powder”. It has conventionally been propagated that when hydrogen is generated by using aluminium, a film formed on the surface of aluminium stops generation of hydrogen in a short period of time, and thus aluminium should be preferably used as a “powder”. However, in the invention, since a heated aqueous sodium bicarbonate solution or aqueous sodium carbonate solution is considered to prevent film formation on the surface of aluminium 76, a mass of aluminium can be used, and thus a time of hydrogen generation can be made longer by using the aluminium as a mass rather than as a powder.

Next, a method to stop generation of hydrogen during the reaction will be described. A mass of aluminium contained in the accommodation means 72 shown in FIG. 5 as well as a fine particle or a powder of aluminium contained in the accommodation means 77 shown in FIG. 6 are immersed under the liquid surface 74 in the case of generating hydrogen. By this, hydrogen is generated in the container 60 by a reaction of aluminium 76 with aqueous sodium bicarbonate solution or aqueous sodium carbonate solution. Thereafter, if generation of hydrogen is intended to be stopped during the reaction, the accommodation means 72 and 77 are raised by operating the elevation means 95 to move aluminium 76 above the liquid surface 74 of the aqueous sodium bicarbonate solution or the aqueous sodium carbonate solution. As a result, since the aluminium 76 does not come into contact with the aqueous sodium bicarbonate solution nor with the aqueous sodium carbonate solution, generation of hydrogen can be stopped immediately.

After this, in order to resume generation of hydrogen, the accommodation means 72 and 77 are raised by operating the elevation means 95 so that the aluminium 76 contained in the accommodation means 72 and 77 are immersed in the aqueous sodium bicarbonate solution or the aqueous sodium carbonate solution. In this manner, generation of hydrogen and stopping of hydrogen generation can be carried out promptly by moving the aluminium 76 above or under the liquid surface 74, thereby expanding the application range of hydrogen as energy.

In another method to stop generation of hydrogen during the reaction, an aqueous sodium bicarbonate solution or an aqueous sodium carbonate solution in the container 60 may be discharged outside from the discharge pipe 98 attached to the bottom of the container 60. After this, in order to resume generation of hydrogen, an aqueous sodium bicarbonate solution or an aqueous sodium carbonate solution may be introduced into the container 60 from the aqueous solution introducing tube 66.

In the foregoing descriptions, hydrogen is generated under a condition that the aluminium 76 was immersed under the liquid surface 74 in the container 60. Then, a method in which hydrogen is generated under a condition that the aluminium 76 was positioned above, the liquid surface 74 will be described. In this case, a mass of aluminium 76 is contained in the accommodation means 72, in which the mass of aluminium 76 is positioned above the liquid surface 74 by operating the elevation means 95. Water (any type of water may be acceptable) and sodium bicarbonate is fed into the container 60, and then heated by the heating means 90. A temperature to heat the inside of the container 60 is set at an evaporating temperature of the aqueous sodium bicarbonate solution. The vapor of the sodium bicarbonate comes into contact with the mass of aluminium 76 by evaporating the aqueous sodium bicarbonate solution. As a result, sodium bicarbonate attaches to the surface of the mass of aluminium 76, and hydrogen is generated from a vapor, the mass of aluminium 76 and sodium bicarbonate. A process in which a vapor of aqueous sodium bicarbonate solution is applied to the mass of aluminium 76 so that the structure of aluminium 76 is reformed to generate hydrogen is referred to as “vapor reformation”.

When aluminium is reformed with vapor by using 100 wt of water, 20 wt of mass of aluminium and 20 wt of sodium bicarbonate, if refreshed water was used, hydrogen was generated stably for 45 minutes. Under the same condition, if purified water was used, hydrogen was generated stably for 30 minutes, and if city water was used hydrogen was generated stably for 25 minutes. In this manner, when the aluminium 76 was reformed with vapor by using the mass of aluminium 76 and sodium bicarbonate, a substantially same amount of hydrogen can be generated as in the case where the aluminium 76 was immersed under the liquid surface 74 of the refreshed water.

In a process of generating hydrogen by reforming aluminium with vapor, in order to stop the generation of hydrogen during the reaction, the mass of aluminium 76 contained in the accommodation means 72 and the liquid surface 74 of aqueous sodium bicarbonate solution are hermetically isolated by an isolation means (not shown), or otherwise an aqueous sodium bicarbonate solution in the container 60 is discharged outside from the discharge pipe 98 attached to the bottom of the container 60.

1. A method for producing hydrogen, characterized in that 100 wt of water, 1 wt or more of aluminium and 1 wt or more of either sodium bicarbonate or sodium carbonate are fed into a container, and an aqueous sodium bicarbonate solution or an aqueous sodium carbonate solution in the container is heated to 60° C. or higher by a heating means.

2. The method for producing hydrogen according to claim 1, characterized in that a weight of the aluminium was set at not less than 10 wt.

3. The method for producing hydrogen according to claim 1, characterized in that a weight of at least one of the sodium bicarbonate or the sodium carbonate is set at not less than 10 wt.

4. The method for producing hydrogen according to claim 1, characterized in that an accommodation means is movably provided in the container in a vertical direction, the aluminium is contained in the accommodation means, the aluminium is immersed under a liquid surface within the container to generate hydrogen, and the aluminium is raised above the liquid surface within the container by raising the accommodation means to stop generation of hydrogen.

5. The method for producing hydrogen according to claim 1, characterized in that a discharge pipe for discharging water outside from the container is provided in the vicinity of the bottom of the container, an on-off valve is provided in the middle of the discharge pipe, an aqueous sodium bicarbonate solution or an aqueous sodium carbonate solution in the container is discharged from the discharge pipe to stop generation of hydrogen.

6. The method for producing hydrogen according to claim 1, characterized in that a thermometer for measuring a temperature inside of the container and a barometer for measuring a pressure inside of the container are provided, a computer for operating the heating means in response to a temperature inside of the container measured by the thermometer and a pressure inside of the container measured by the barometer is provided, and the computer controls the heating means so that a temperature of aqueous sodium bicarbonate solution or aqueous sodium carbonate solution in the container is kept to a level that hydrogen can be generated maximally in a unit of time.

7. The method for producing hydrogen according to claim 6, characterized in that a temperature to which an aqueous sodium bicarbonate solution or an aqueous sodium carbonate solution in the container is heated and kept by the heating means is set at 86° C. to 97° C.

8. The method for producing hydrogen according to claim 1, characterized in that at least one of the sodium bicarbonate or the sodium carbonate is used as a sodium bicarbonate, a temperature at which an aqueous sodium bicarbonate solution is heated by the heating means is used as a temperature to evaporate the solution, a vertically movable accommodation means is provided in the container, a mass of the aluminium is contained in the accommodation means, the aluminium is positioned above a liquid surface within the container to generate hydrogen, and a vapor of the aqueous sodium bicarbonate solution is applied to the mass of aluminium.

9. The method for producing hydrogen according to claim 8, characterized in that a space between the aluminium and the liquid surface is isolated hermetically using an isolation member to stop generation of hydrogen.

10. The method for producing hydrogen according to claim 8, characterized in that a discharge pipe for discharging water outside from the container is provided in the vicinity of the bottom of the container, an on-off valve is provided in the middle of the discharge pipe, and an aqueous sodium bicarbonate solution in the container is discharged from the discharge pipe to stop generation of hydrogen.

11. The method for producing hydrogen according to claim 1, characterized in that water to be fed into the container is a specific type of water produced in a process where water is passed firstly through an ion exchange resin, next through tourmaline, and subsequently through rocks including 65 to 76 wt % of silica dioxide and comprising at least one of rhyolite or granite, either in this order or in the order tourmaline and the rocks are reversed.

12. The method for producing hydrogen according to claim 11, characterized in that tourmaline is mixed with at least one kind of metals such as aluminium, stainless steel and silver to produce the specific type of water.

13. The method for producing hydrogen according to claim 11, characterized in that the rhyolite is a rock comprising at least one of obsidian, pearlstone or pitchstones.
